(19) United States
(12) Patent Application Publication
(10) Pub. No.: US 2003/0042331 A1
(43) Pub. Date: Mar. 6, 2003

(54) Multiple function spray nozzle

(76) Inventor: Kuo-Chou Lu, Changhwa City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/883,284

(22) Filed: Jun. 19, 2001

(51) Int. Cl. A62C 31/00; B05B 1/14

(52) U.S. Cl. 239/436; 239/441; 239/440; 239/447; 239/556

(57) ABSTRACT

A spray nozzle has a head, a cap and a middle plate. The head has a discharge channel. The cap is rotatably mounted on the head. A circular baffle is formed on the cap and has a space defined inside the baffle. Multiple nozzle units and a closed tube communicating with the space in the baffle are formed on the baffle. Multiple bores are defined in the cap and communicate with the space in the baffle. Multiple misting nozzles are mounted on the cap outside the baffle. The middle plate is secured in the cap. Multiple through holes are defined in the plate in a circle. Each nozzle unit on the baffle and the closed tube aligns with one of the through holes. Accordingly, the water can be sprayed from the spray nozzle in different forms. The using of the spray nozzle becomes more versatile.

### BACKGROUND OF THE INVENTION

1. Field of the Invention

The present invention relates to a spray nozzle, and more particularly to a spray nozzle that can spray water in different forms.

2. Description of Related Art

A spray nozzle connected to a water source through a hose is always used in the garden. The conventional spray nozzle in accordance with the prior art substantially comprises a head and a cap. The head is connected to the hose and has a discharge channel. The cap is rotatably mounted on the head. Multiple nozzle units like a high pressure nozzle, a soaker nozzle, a misting nozzle, a cone nozzle or a fan nozzle are mounted on the cap. When the cap is rotated and one of the nozzle units aligns with the discharge channel, water is sprayed from the aligned nozzle unit in a desired form. However, the versatility of the conventional spray nozzle is not very good, and a spray nozzle with more capabilities is needed.

To overcome the shortcomings, the present invention tends to provide an improved spray nozzle to mitigate or obviate the aforementioned problems.

### SUMMARY OF THE INVENTION

The main objective of the invention is to provide an improved spray nozzle with multiple capabilities. The spray nozzle has a head, a cap and a middle plate. A discharge channel is defined in a first side of the head. The cap has a skirt around the edge of the cap and is rotatably mounted on a first side of the head. A circular baffle is formed on the cap on the side facing the head and has a space defined in the baffle. Multiple nozzle units are formed on the outer periphery of the baffle. A closed tube communicating with the space in the baffle is formed on the outer periphery of the baffle. Multiple bores are defined in the cap and communicate with the space in the baffle. Multiple misting nozzles are formed on the cap on the side facing the head and outside the baffle. The middle plate is secured in the cap. Multiple through holes are defined in the plate in a circle. There are more through holes than nozzle units on the baffle. Each nozzle unit on the baffle aligns with one of the through holes. One of the through holes aligns with the discharge channel. With such an arrangement, the water discharged from the discharge channel can be sprayed from one of the nozzle units, the bores in the baffle or the misting nozzles through the aligned through hole. The use of the spray nozzle becomes more versatile.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a spray nozzle in accordance with the present invention;

FIG. 2 is an exploded perspective view of the spray nozzle in FIG. 1;

FIG. 3 is a rear plan view of a cap with a stream slicer of the spray nozzle in FIG. 1;

FIG. 4 is an enlarged exploded perspective view in partial section of the middle plate and one of the misting nozzles on the cap in FIG. 1;

FIG. 5 is a cross sectional plan view of a misting nozzle on the cap and a post on the middle plate in FIG. 4; and

FIG. 6 is a cross section plan view of another embodiment of a misting nozzle on the cap in accordance with the present invention.

### DETAILED DESCRIPTION OF PREFERRED EMBODIMENT

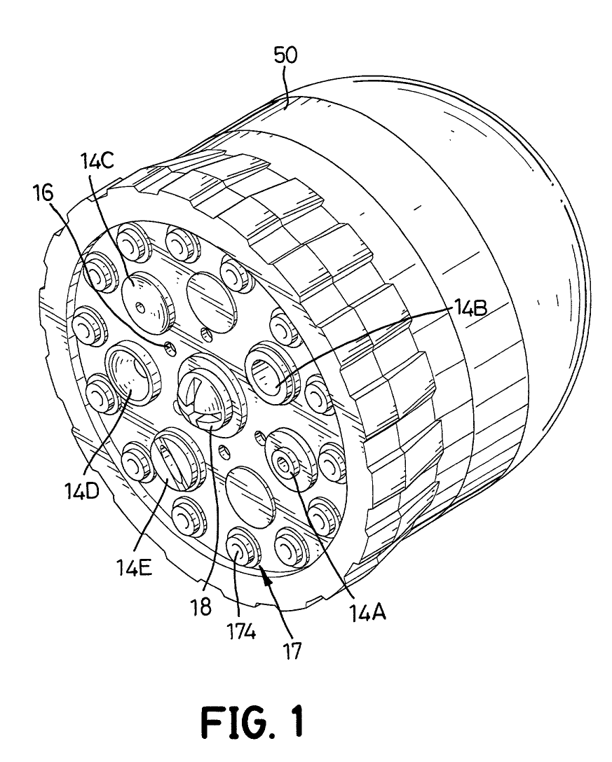

With reference to FIGS. 1 to 3, a spray nozzle in accordance with the present invention comprises a hollow head (50), a cap (10) and a middle plate (20). The head (50) is connected to a water source with a hose (not shown). A discharge channel (52) is defined in a first side of the head (50). A central tub (51) extends outward from the first side of the head (50).

The cap (10) is rotatably mounted on the central tube (51) on the head (50). A central tube (11) with a central passage (102) is formed on the cap (10) to mate with the central tube (51) on the head (50). A screw (18) extends into the central tubes (11,51) on the cap (10) and the head (50) to screw into an inner thread (not shown) defined in the head (50), such that the cap (10) is rotatably mounted on the head (50). A skirt (104) is formed around the edge of the cap (10) so that a space is defined inside the skirt (104). A circular baffle (12) is formed on the cap (10) around the central tube (11) on the side facing the head (50), and an inner space (13) is defined inside the baffle (12) and an outer space is defined inside the skirt and outside the baffle (12). Multiple bores (16) are defined in the cap (10) at a position inside the inner space (13) in the baffle (12) and communicate with the space (13) in the baffle (12).

A stream slicer (30) is rotatably mounted in the inner space (13) in the baffle (12). The stream slicer (30) has a central ring (31) and multiple blades (32). The central ring (31) is rotatably mounted on the central tube (11) on the cap (10). The blades (32) tangentially extend from the central ring (31). Consequently, the stream slicer (30) will rotate relative to the cap (10) when water flows into the baffle (12). A web (33) is formed between one pair of adjacent blades (32) to close a corresponding bore (16) in the cap (10).

Multiple nozzle units (14A, 14B, 14C, 14D, 14E) are formed on an outer periphery of the baffle (12). One of the nozzle units (14A, 14B, 14C, 14D, 14E) can be a high pressure nozzle (14A), a soaker nozzle (14B), a misting nozzle (14C), a cone nozzle (14D) or a fan nozzle (14E). A closed tube (15) communicating with the inner space (13) in the baffle (12) is formed on the outer periphery of the baffle (12). A passage (152) is defined in the baffle (12) to allow the closed tube (15) to communicate with the inner space (13) inside the baffle (12). The passage (152) communicating between the inner space (13) and the close tube (15) is defined parallel to a tangent of the central ring (31) of the stream slicer (30). Accordingly, each blade (32) faces the passage (152), and the impacting area of each blade (32) is increased.

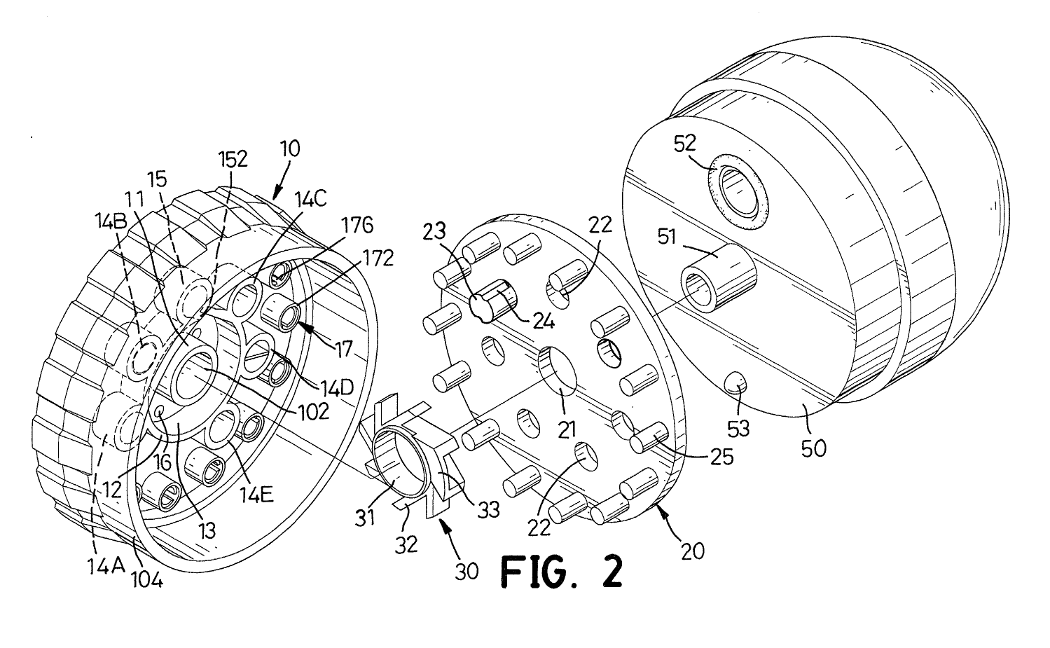

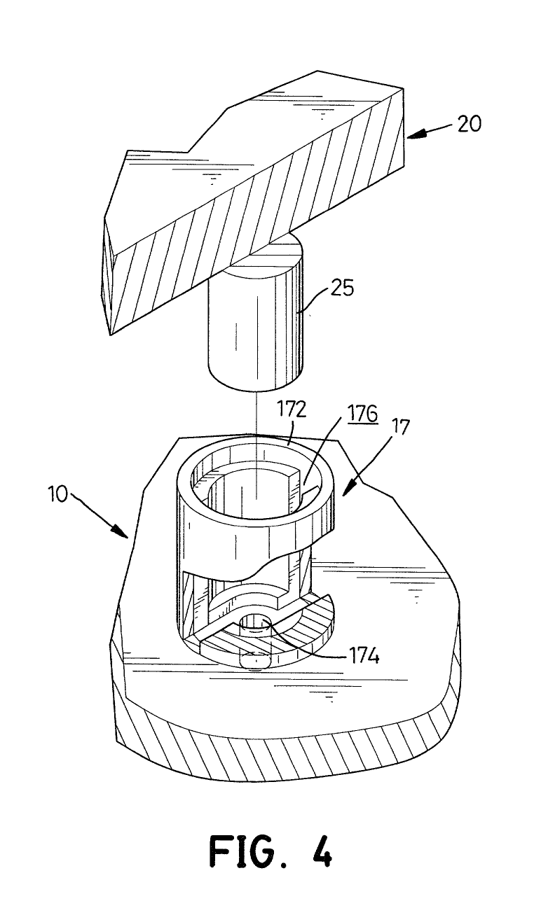

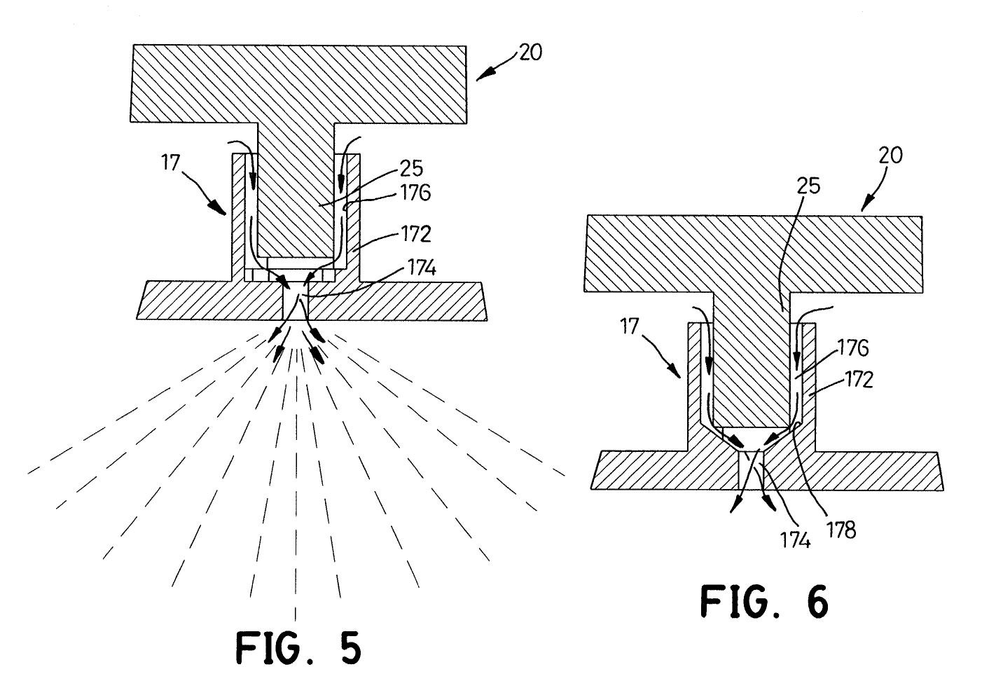

Multiple misting nozzles (17) are mounted on the cap (10) on the side facing the head (50) outside the baffle (12). With reference to FIGS. 2 to 5, each misting nozzle (17) has a height shorter than that of each nozzle unit (14) on the baffle (12). Each misting nozzle (17) includes a tube (172) and an opening (174). The tube (172) is mounted on the cap (10). At least one channel (176) is longitudinally defined in the tube (172). The opening (174) is defined in the cap (10) and communicates with the channels (176). With reference to FIG. 6, an inclined passage (178) is defined in the tube (172) to communicate the opening (174) and each channel (176) in the tube (172).

The middle plate (20) is secured in the cap (10) and abuts all of the nozzle units (14) on the baffle (12) and the baffle (12) to divide the space in the skirt (104) into two chambers. A central hole (21) is defined in the middle plate (20) so the central tube (51) on the head (50) can extend through the central hole (21). Multiple through holes (22) are defined in the plate (22) in a circle. There are more through holes (22) than nozzle units (14) on the baffle (12) and the closed tube (15). Each nozzle unit (14) on the baffle (12) and the closed tube align with one of the through holes (22). Consequently, at least one through hole (22) does not correspond to the nozzle units (14) on the baffle (12) and the closed tube (15). One of the through holes (22) aligns with the discharge channel (52) in the head (50).

A stub (23) is mounted in the through hole (22) aligning with the misting nozzle (14C) on the baffle (12) and extends into the misting nozzle (14C) on the baffle (12). Two grooves (24) are longitudinally defined along the outer periphery of the stub (23) to communicate with the through hole (22) in which the stub (23) is mounted. Consequently, the water can flow into the misting nozzle (14C) on the baffle (12) through the grooves (24) on the stub (23).

A positioning pin (53) is retractably mounted on the head (50) and extends into one of the through holes (22) to hold the middle plate (20) and the cap (10) relative to the head (50). Multiple posts (25) are integrally formed on the middle plate (20) and each extends into a corresponding misting nozzles (17).

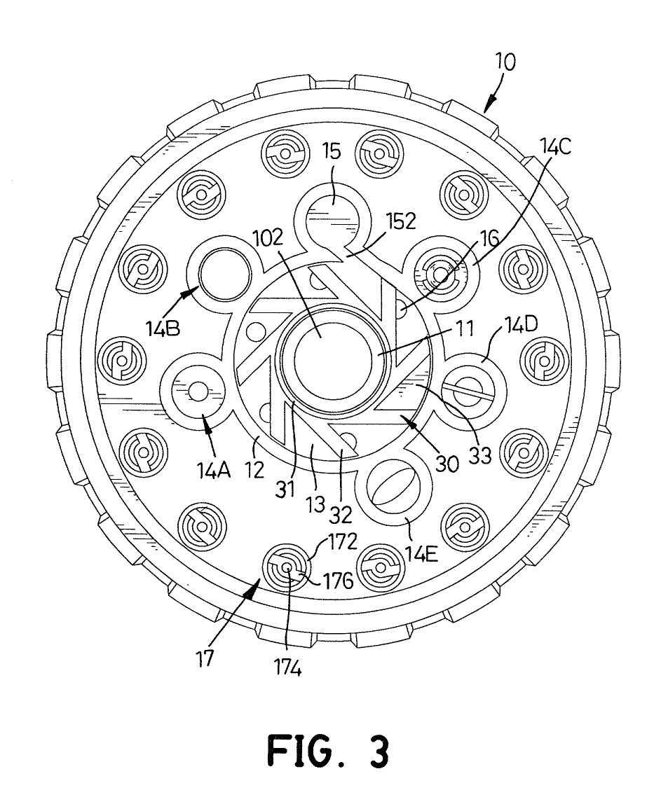

In operation, with reference to FIGS. 2 and 3, when the cap (10) is rotated and one of the nozzle units (14) on the baffle (12) aligns with the discharge channel (52) in the head (50), for example the high pressure nozzle (14A), the water will be sprayed from the high pressure nozzle (14A) in a desired form through the through hole (22) aligning with the high pressure nozzle (14A). When the cap (10) is rotated and another nozzle unit(14A, 14B, 14C, 14D, 14E) aligns with the discharge channel (52), the water will be sprayed from the nozzle unit (14A, 14B, 14C, 14D, 14E) in a different form through the through hole (22) aligned with the nozzle unit (14A, 14B, 14C, 14D, 14E).

When the cap (10) is rotated and the closed tube (15) aligns with the discharge channel (52), water will flow into the closed tube (15) through the through hole (22) aligned with the closed tube (15). Water will flow into the inner space (13) in the baffle (12) through the passage (152) and be sprayed from the bores (16). The water is sprayed in another form. In addition, because the stream slicer (30) is mounted in the baffle (12), the stream slicer (30) will rotate relative to the cap (10) due to the impact of the water applied to the blades (32). Because there is a web (33) formed between a pair of adjacent blades (32) on the stream slicer (30), the bores (16) will be closed momentarily by the web (33) in turn. Accordingly, the water will not be sprayed from the closed bore (16). An intermittent effect is achieved.

When the cap (10) is rotated and none of the nozzle units (14) on the baffle (12) or the closed tube (15) aligns with the discharge channel (52), water will flow into the space in the skirt (104) outside the baffle (12). The water will then flow into the misting nozzles (17) outside the baffle (12). With reference to FIGS. 2, 4 to 6, the water will be sprayed from the opening (174) of each misting nozzle (17) in a mist form through the channels (176) and the inclined passages (178) in each misting nozzle (17). Another type of spraying effect is achieved. Accordingly, the user can selectively spray water in many different forms with the spray nozzle by means of rotating the cap (10). The use of the spray nozzle becomes more versatile. In addition, the channels (176) defined in the tube (172) in each misting nozzle (17) are located in a position and a direction different from those of the channel (176) of the other misting nozzle (17). Consequently, the water can be sprayed from the misting nozzles (17) in different directions. The misting effect of the spray nozzle is improved.

In another embodiment, the nozzle units (14A, 14B, 14C, 14D, 14E) and the closed tube (15) can be mounted on the inner periphery of the baffle (12). The misting nozzles (17) are mounted inside the baffle (12), and the bores (16) are defined in the cap (10) outside the baffle (12). The passage (152) is defined in the baffle (12) to communicate with the closed tube (15) and the space outside the baffle (12). A spray nozzle with a different structure and the same capabilities is achieved.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A spray nozzle comprising:
a hollow head having a discharge channel defined in a first side of the head;
a cap with a skirt around an edge of the cap to be rotatably mounted on the first side of the head and having:
a circular baffle formed on the cap to define an inner space inside the baffle and an outer space inside the skirt and outside the baffle;
multiple nozzle units formed in a circle on the baffle;
a closed tube formed on the baffle in the circle of the nozzle units to selectively communicate with the inner space and the outer space inside the skirt;
multiple bores defined in the cap to selectively communicating with of the inner space and the outer space inside the skirt; and
multiple misting nozzles mounted on the cap in a space opposite to the space containing the bores; and
a middle plate secured in the cap and abutting all of the nozzle units on the baffle and the baffle divides a space defined inside the skirt into two chambers and having:
multiple through holes defined in the plate in a circle,
wherein a number of the through holes is larger than a number of the nozzle units on the baffle and the close tube so that at least one through hole in the middle plate communicates with the misting nozzles;each nozzle unit on the baffle aligns with one of the through holes; and
one of the through holes aligns with the discharge channel in the head,
whereby water discharged from the discharge channel can be sprayed from one of the nozzle units, the bores in the baffle or the misting nozzles through the aligning through hole.

2. The spray nozzle as claimed in claim 1, wherein a passage is defined in the baffle to communicate between the closed tube and the space inside the skirt with the bores.

3. The spray nozzle as claimed in claim 2, wherein the nozzle units on the baffle and the closed tube are formed on an outer periphery of the baffle;
the bores are defined in the cap at a position corresponding to the inner space inside the baffle; and
the misting nozzles are mounted on the cap at a position corresponding to the outer space inside the skirt.

4. The spray nozzle as claimed in claim 3 further comprising a stream slicer rotatably mounted in the inner space inside the skirt and having:
a central ring rotatably received in the inner space of the baffle; and
multiple blades tangentially extending from the central ring,
whereby the stream slicer will rotate relative to the cap when water flows into the baffle and is sprayed from the bores.

5. The spray nozzle as claimed in claim 4, wherein a web is formed between a pair of adjacent blades to sequentially close one of the bores in the cap.

6. The spray nozzle as claimed in claim 4, wherein the passage communicating between the inner space in the skirt and the close tube is defined parallel to a tangent of the central ring to increase the impact area of the blade.

7. The spray nozzle as claimed in claim 4, wherein a central hole is defined in the middle plate;
a first central tube is formed on the first side of the head to extend into the central hole in the middle plate;
a second central tube is formed on the cap to mate with the first central tube of the head; and
a screw extends into the second central tubes on the cap and the head to screw into an inner thread defined in the head so as to rotatably attach the cap to the head.

8. The spray nozzle as claimed in claim 7, wherein the central ring of the stream slicer is rotatably mounted on the central tube on the cap.

9. The spray nozzle as claimed in claim 2, wherein the nozzle units on the baffle and the closed tube are formed on an inner periphery of the baffle;
the bores are defined in the cap at a position corresponding to the outer space inside the skirt; and
the misting nozzles are mounted on the cap at a position corresponding to the inner space inside the skirt.

10. The spray nozzle as claimed in claim 1, wherein a positioning pin is retractably mounted on the first side of the head to extend into one of the through holes in the middle plate so as to hold the middle plate in position.

11. The spray nozzle as claimed in claim 1, wherein posts are integrally formed on the middle plate to extend into each misting nozzle.

12. The spray nozzle as claimed in claim 11, wherein each misting nozzle has a height shorter than that of each nozzle unit on the baffle and includes:
a tube mounted on the cap;
at least one channel defined in the tube; and
an opening defined in the cap and communicating with the at least one channel,
whereby water can be sprayed from the opening of each misting nozzle through the at least one channel in the tube.

13. The spray nozzle as claimed in claim 12, wherein an inclined passage is defined in the tube of each misting nozzle to communicate between the opening and each of the at least one channel in the tube.

14. The spray nozzle as claimed in claim 12, wherein the channels defined in the tube of each misting nozzle are located in a position and a direction different from those of the channel of the other misting nozzles,
whereby the water is sprayed from the misting nozzles in different directions.

15. The spray nozzle as claimed in claim 1, wherein one of the nozzle units on the baffle is a high pressure nozzle.

16. The spray nozzle as claimed in claim 1, wherein one of the nozzle units on the baffle is a soaker nozzle.

17. The spray nozzle as claimed in claim 1, wherein one of the nozzle units on the baffle is a misting nozzle.

18. The spray nozzle as claimed in claim 17, wherein a stub is mounted in the through hole aligning with the misting nozzle on the baffle and extends into the misting nozzle on the baffle; and
two grooves are longitudinally defined along an outer periphery of the stub to communicate with the through hole on which the stub is mounted.

19. The spray nozzle as claimed in claim 1, wherein one of the nozzle units on the baffle is a cone nozzle.

20. The spray nozzle as claimed in claim 1, wherein one of the nozzle units on the baffle is a fan nozzle.
